(19) United States
(12) Patent Application Publication
(10) Pub. No.: US 2025/0137210 A1
(43) Pub. Date: May 1, 2025

(54) Chip Enabled Raised Pavement Markers (CERPMs) for Enhanced Perception and Sensing in Intelligent Transport Systems (ITS)

(71) Applicant: Board of Trustees of Western Michigan University, Kalamazoo, MI (US)

(72) Inventors: Zachary D. Asher, Kalamazoo, MI (US); Richard Meyer, Portage, MI (US); Sachin Sharma, Kalamazoo, MI (US); Timothy J. Laclair, Lenoir City, TN (US); Ali Riza Ekti, Knoxville, TN (US); Chieh Wang, Knoxville, TN (US); Shean P. Huff, Knoxville, TN (US)

(21) Appl. No.: 18/929,581

(22) Filed: Oct. 28, 2024

Related U.S. Application Data
(60) Provisional application No. 63/593,651, filed on Oct. 27, 2023.

(51) Int. Cl. E01F 11/00; H04W 4/02; H04W 4/44; H04W 84/04

(52) U.S. Cl. CPC E01F 11/00; H04W 4/025; H04W 4/44; H04W 84/04

(57) ABSTRACT

Embodiments of the present disclosure may include a chip-enabled raised pavement marker (CERPM) that includes a transceiver, wherein said transceiver is capable of transmitting the location of the CERPM to a vehicle, wherein said CERPM is capable of being fixed on a roadway surface and has dimensions of standard raised pavement markers. Systems and aspects of the present disclosure may include a method of guiding an autonomous or semi-autonomous vehicle, including using an on-board receiver to receive transmissions from a chip-enabled raised pavement marker (CERPM), wherein the transmissions comprise the location of the CERPM to the receiver; indicating the position of the vehicle relative to lane lines, edges of the drivable surface and/or obstacles based on the transmitted CERPM signal.

### CROSS-REFERENCE TO RELATED APPLICATIONS

This application claims the benefit of U.S. Provisional Application No. 63/593,651, filed Oct. 27, 2023. The entire contents of the prior application are incorporated by reference herein.

### STATEMENT REGARDING FEDERALLY SPONSORED RESEARCH OR DEVELOPMENT

The United States Government has rights in this invention pursuant to contract no. DE-AC05-00OR22725 between the United States Department of Energy and UT-Battelle, LLC.

### TECHNICAL FIELD

The present disclosure relates to systems and methods that improve autonomous and semi-autonomous vehicle navigation via chip-enabled raised pavement markers (CERPMs), infrastructure-based wireless communication devices able to communicate a variety of information to vehicles as a simple, low-cost way to improve accuracy of navigation in a wider range of driving conditions as well as lower the computing and sensor cost and time for on-board computers for autonomous and semi-autonomous vehicle navigation.

### BACKGROUND OF THE INVENTION

Traditional raised pavement markers (RPMs) are found on roadways throughout the United States and across the globe, especially on high-volume highways and roads having low visibility. These are most often passive reflectors that do not contain any embedded electronic communication devices, limiting their ability to further aid in navigation, such as being able to communicate with autonomous or semi-autonomous vehicles. The present disclosure relates to the use of the basic structure of RPMs as a housing for very simple, low-cost electronic devices that can provide information to passing vehicles while simultaneously enabling a variety of sensing and data collection functions, with different options available to allow flexibility for different situations. The chip-enabled RPMs, or CERPMs, described herein are energy-efficient infrastructure-based wireless communication devices embedded within an RPM (and ultimately into the roadway), which can, in some embodiments, be combined with other sensors for real-time traffic and environment monitoring in a timely manner. An embodiment may integrate electronic communication, sensing, and/or basic data processing capabilities into an RPM to enable a diverse range of Intelligent Transportation System (ITS) capabilities, effectively serving as simple roadside units (RSUs). CERPMs may be powered by a battery (and an expected battery life of at least several months would be possible with currently available low-powered electronics), but energy-harvesting capabilities may also be employed if needed for longer life by using integrated solar cells, piezoelectric vibration generators, or other approaches.

### SUMMARY OF THE INVENTION

Embodiments of the present disclosure may include a chip-enabled raised pavement marker (CERPM) that includes a transceiver, wherein said transceiver is capable of transmitting the location of the CERPM to a vehicle, wherein said CERPM is capable of being fixed on a roadway surface and has dimensions of standard raised pavement markers. In other embodiments, the transceiver is capable of transmitting location of the CERPM to a vehicle using a low-power wide-area network (LPWAN). In yet others, the LPWAN uses LoRA, NB-Iot, SigFox, Telensa, and/or Ingenu RPMA.

In others, the location of the CERPM is indicated with location coordinates. In yet others, the location coordinates are GPS coordinates. In still other embodiments, the CERPM is capable of transmitting said location to a vehicle using radio transmission. In other embodiments, the CERPM further includes a reflective upper surface capable of aiding in visual detection by vehicle drivers and/or cameras or other visual sensors in autonomous or semi-autonomous vehicles.

Aspects of the present disclosure may include a method of guiding an autonomous or semi-autonomous vehicle, including using an on-board receiver to receive transmissions from a chip-enabled raised pavement marker (CERPM), wherein the transmissions comprise the location of the CERPM to the receiver; indicating the position of the vehicle relative to lane lines, edges of the drivable surface and/or obstacles based on the transmitted CERPM signal.

In other aspects, the receiver communicates to the CERPM using a low-power wide-area network (LPWAN). In others, the location of the CERPM is indicated with location coordinates.

In other aspects, indicating the position of the vehicle based on the transmitted CERPM signal further includes combining CERPM location data with onboard sensor data to indicate the relative position of the vehicle such that computing the relative position of the vehicle is less computationally intense than using onboard sensor data alone. In others, the onboard sensor includes one or more cameras. In others, where the onboard sensor includes one or more radar sensors.

Other embodiments of the present disclosure may include a system for guiding an autonomous or semi-autonomous vehicle, including: an on-board receiver to receive transmissions from a chip-enabled raised pavement marker (CERPM), wherein the transmissions comprise the location of the CERPM to the receiver; and an onboard module capable of indicating the position of the vehicle relative to lane lines, edges of the drivable surface and/or obstacles based on the transmitted CERPM signal.

In others, the receiver communicates to the CERPM using a low-power wide-area network (LPWAN). In others, the transmission obtained from the CERPM includes location coordinates.

In other embodiments, the system further includes an onboard sensor capable of obtaining position data relative to lane lines/road edges and or obstacles; and wherein the onboard module is capable of combining the CERPM location data with the position data from the onboard sensor to indicate the relative position of the vehicle such that computing the relative position of the vehicle is less computationally intense than using onboard sensor data alone.

In others, the onboard sensor includes at least one camera. In others, the onboard sensors includes at least one radar sensor.

Further embodiments of the system may include a chip-enabled raised pavement marker (CERPM) including: a transceiver, wherein said transceiver is capable of transmitting the location of the CERPM to a vehicle, wherein said CERPM is capable of being fixed on a roadway surface and has dimensions of standard raised pavement markers.

### BRIEF DESCRIPTION OF THE DRAWINGS

The present invention(s) are illustrated by way of example and not limitation with reference to the accompanying drawings, in which like references generally indicate similar elements or features.

FIG. 1 depicts an example embodiment of (a) a chosen RPM and (b) IoT board and battery placement inside an RPM;

FIG. 2 depicts a measurement setup at the Oak Ridge National Laboratory (ORNL) testing facility for range measurements;

FIG. 3 depicts an example aspect and embodiment flowchart showing a CERPM dat routing plan;

FIG. 4 depicts a road section for testing purposes around the Western Michigan University testing site for lane line and drivable detection testing;

FIG. 5 depicts a chart showing received power comparison (in dBm);

FIG. 6 shows real-time lane line and drivable region detection using example embodiment CERPMs of the present disclosure;

FIG. 7 shows transmitter setups for example embodiment CERPMs;

FIG. 8 depicts a diagram of vehicle lane information obtainable from example embodiment CERPMs;

FIG. 9 shows U-Net architecture for image segmentation in aspects of the present disclosure;

FIG. 10 depicts inputs to the U-Net architecture, masked output, selected region of interest and perspective transformation of the selected region in aspects of the present disclosure: (a) input image, (b) U-Net output; (c) RDI extraction, and (d) perspective transform;

FIG. 11 depicts Step 2 in some example aspects of the present disclosure, for lateral offset estimation showing the sliding window method and inverse perspective transform of the warped image;

FIG. 12 depicts lane line detection from CERPM information in aspects of the present disclosure;

FIG. 13 shows an example road section for lateral offset estimation tests in Town03 of the CARLA simulator, (a) CARLA Town03 road section, (b) X and Y position of the vehicle;

FIG. 14 shows graphs of lateral offset estimators based on single measurement input for (a) CERPM-based estimator and (b) camera-based estimator;

FIG. 15 shows a graph comparing lateral offset estimators based on group sensor methods of the present disclosure;

FIG. 16 depicts lateral offset estimators based on asynchronous fusion of CERPM-camera measurements;

FIG. 17 is a photograph of RPMs on a highway.

### DETAILED DESCRIPTION

Typical Autonomous Vehicle (AV) systems can be divided into four main subsystems: perception, localization, path planning, and control. For perception, AVs use input from multiple sensors to extract information about the driving environment and locate current and future states of stationary and dynamic objects using cameras, radio detection and rangings (RADARs), and light detection and rangings (LIDARs). Incoming data from AV sensors and information sources are typically fused and interpreted using advanced sensor fusion algorithms for highly accurate perception and localization subsystems, which requires a vehicle computer with very high operating frequencies and multiple processors.

Given the outputs from perception and localization subsystems, the path planning subsystem finds an optimal and safest trajectory for the AV to reach its desired destination. The control subsystem outputs required acceleration, torque, and steering angle values to follow the trajectory obtained through path planning. Power drawn from all the AV sensors including the in-vehicle computer, the computational load from sensor fusion algorithms for perception and localization, as well as both path planning and control execution reduce the energy efficiency of an AV.

By combining alternative sensor fusion methodologies with optimal energy management techniques, AV energy usage can be significantly reduced. The present disclosure describes various systems and methods for reducing the computational burden of perception and location for AV and semi-autonomous vehicles (SAV). A SAV can range from partial driving assistance (steering away from detected obstacles, back into the proper lane after swerving out of the proper lane) to warning lights, alarms and the like.

Lane detection, which can be considered as an output of the perception process, is a crucial task for AVs and advanced driver assistance systems (ADAS) in SAVs. (Note that for conciseness, term AVs is defined here to be inclusive of SAVs, unless otherwise stated.) Usual computer vision-based lane detection technology relies on image processing algorithms to extract lane line features, reduce image channels, extract features of the acquired image, and fit lane lines post-extraction. However, recent advances in deep learning have led to neural network-based lane detection methods with higher accuracy. In most lane-detection models based on deep learning, each pixel obtained through semantic segmentation is assigned to a category indicating whether it belongs to a lane line or not. While succeeding where traditional algorithms fail in complex road scenarios, such as lack of lane lines, blocked lanes, and poor light, neural network-based lane detection algorithms demand higher computational power, as a larger and deeper convolutional network is required to extract high-level semantic information. To reduce AV compute load and its negative effects on vehicle energy efficiency, we propose a new infrastructure information source (IIS) to provide environmental data to the AV.

In order to enhance the detection accuracy for deep-learning algorithms, low-cost sensors such as raised pavement markers (RPMs) can be utilized to support and provide more information to accurately identify lane lines. RPMs usually include retro-reflectors and are found on roadways throughout the United States, especially on high-volume highways and low-visibility roads. They contain no sensors, communications hardware, or any other electronics, however, and are thus limited in the amount of information they can convey to on-vehicle sensors during sub-optimal conditions such as high daylight, poor weather, and snow cover, amongst others.

To overcome this issue, the present disclosure uses infrastructure-based sensors designed to facilitate perception and sensing by supporting vehicle-to-infrastructure (V2I) information exchange. In some embodiments and aspects, the sensor, a chip-enabled raised pavement marker (CERPM), is capable of wireless communications to exchange environment information with AVs. This invention includes an electronic circuit inside of a standard RPM, or comprises a device having the footprint of a traditional RPM (usually, but not necessarily including a retroreflector on the top surface) for ease of placement and adherence to current methods and road safety standards. This enables communications and a range of sensing capabilities (possible as an add-on in further embodiments). The circuit can in some embodiments, contain a battery for power, but could also include one of various methods to accomplish self-charging, such as vibration, photo-voltaic harvesting of solar energy, etc. Further, long battery life can be achieved using electronics with low-power requirements.

Competing technologies include dedicated remote sensing units that are intended to provide long service life, maximized communication range, and a high level of flexibility for data inputs and communication options. The systems are expensive, are physically much larger, must be installed in a locked cabinet or other secured location, and require sensors to be connected based on specific needs for the installation. Since installation and maintenance intervals are scheduled regularly for RPMs, the low cost of CERPMs of the present disclosure allows them to be economically placed at many more locations along the roadway, allowing for a higher density of sensors and communication devices to cover larger areas of roadway.

In some aspects and embodiments, the CERPMs are placed/attached directly on lane lines, such as center lines, median lines and the like, where the CERPM may reflect and/or be otherwise colored yellow, white, blue or other appropriate color to aid in visual (human navigation) as well as camera detection by onboard computer navigation systems. In some embodiments, CERPMs may be place/attached above the road surface, in some embodiments, CERPMs may be placed in a depression or groove in the road surface, yet still be visible to onboard cameras and motorists; an advantage of being placed in a depression/groove may be to avoid some damage from vehicles, snow plows in cold climates and the like.

In some applications, one row of CERPMs may be placed per road (i.e., on the centerline of the road) in others, more than one row of CERPMs may be placed per road (for example, on the center lines, outside edges of the road, internal lane lines for multi-lane roads). Distinguishing location between more than one row of CEPRMs may done on-board on the vehicle based on the relative location of all the CERPMs detectable by the vehicle on the road to create a road “map” of the road based in whole or in part on locations provided by detected CERPMs; in some aspects and embodiments, location data from the CERPMs may also provide relative location within the road—for instance CERPM is placed on “center lane” line, “northbound/southbound” (for example) lane line (i.e., lane marker is placed in opposite-way lanes or the lanes in current direction of travel), for redundancy or reduce computational burden.

In some aspects and embodiments, CERPMs may be placed within a line, i.e., the middle of a lane, to indicate to on-board sensors the middle of a lane. In such applications, the CERPM may be reflective/colored contrastingly to the road surface or non-reflective and/or colored black/grey/similar to the road surface. In some embodiments, the CEPRM may be reflective or detectable in a wavelength not visible to the human eye, i.e., infrared, ultraviolet and the like, but detectable by onboard camera or other sensors.

A prior proposal has been made to include speed sensors and information display systems in an RPM in US Patent Pub. 2011-0035140, but is not tailored to on-board AV needs. The CERPM disclosed herein has added functions that are beyond what existing RPMs can do. These added functions include capabilities for data processing and wireless data exchange to support various cooperative driving automation (CDA) applications including lane line and drivable region detection for AVs using CERPMs, for example. CERPMs, when developed to transmit the Global Positioning System (GPS) coordinates of their location to the on-board vehicle computer, can help in lane line and drivable region detection for AVs as well.

### CERPMs

Example 1. An off-the-shelf commercially available RPM from Stimsonite was used to test the viability of the concept. The RPM selected for the Example is 11.56 cm in length, 8.08 cm in width, and 1.68 cm in height. Note that, various RPM sizes may be used, such as, for example, conforming to the about 8.9 cm long, 10.1 cm wide, 1.59 cm high dimensions of RPM sold by 3M (Raised Pavement Market Series 290).

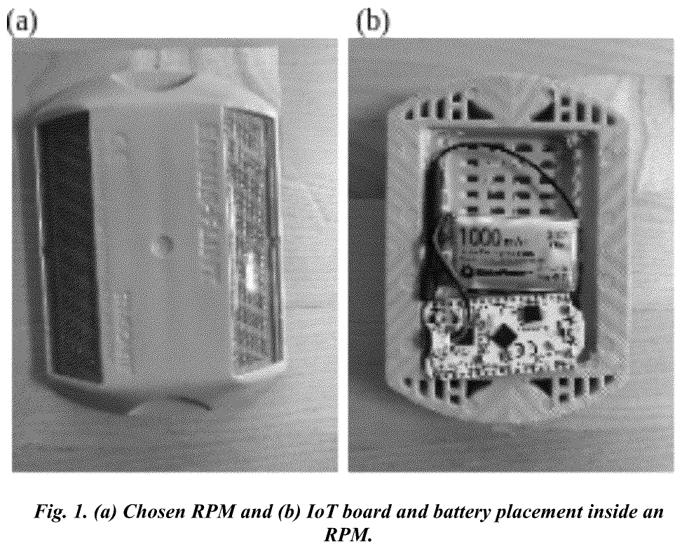

The plastic interior of the RPM was milled to fit the transceiver setup inside it as shown in FIG. 1. Upon milling, the available volume for transmitter setup integration is 65 cm³ (7.62 cm in length, 5.4 cm in width, and 1.40 cm in height). In general, standard RPM sizes may be used, with various depths of cavities used within the RPM to accept the transceiver and/or battery.

In some applications, an “RPM” body may be designed such that the CERPM components and well as any wiring between components fit snugly in the plastic or other material of the RPM. In others, a standard cavity may be used with the components secured inside, with or without filler material to occupy remaining space, waterproof the components etc. In most embodiments, CERPMS have similar or greater resistance to degradation from weather, sun, road salt, vehicle weight etc. as RPMs. Persons of skill in the art will realize that many configurations are possible that fit within the standard RPM footprint, or which may be smaller or larger than the traditional RPM footprint. As noted above, an advantage of a device fitting within current RPM specifications (and/or maintaining RPM reflectivity towards headlights and other light sources) for road use is that they would not need additional regulatory approval.

Example 2. An internet of things (IoT) development board called WiFi LoRa 32 designed by Heltec Automation was used as a transceiver (Tx), as it is integrated with the SX1276 LoRa modem, which supports data transmission in frequency ranges from 137 MHz to 1.02 GHz. The integrated CP2102 USB to serial power chip allows for programming the IoT board using the Arduino library. A 3.7 V Lithium rechargeable battery [1000 mAh battery capacity] was chosen to power the IoT board. These components fit within the available RPM space of 65 cm³ inside the example RPM described above in Example 1.

Similar to the transceiver setup, the same IoT development board was used for the receiver (Rx) setup as well. However, the original antenna that came with the transceiver module for the IoT board (Rx) was replaced with a AEACAQ190012-S915 antenna for increased antenna gain of 0.5 dBi.

An energy-efficient communication protocol that supports long-range communication was considered essential to justify the reasoning behind mass adoption of CERPMs. Long-range (LoRa) is a low-power wide-area network (LPWAN) technology that enables energy-efficient communications over longer distances, and it has been applied to a wide range of smart and sustainable transportation applications. Alternative LPWAN technologies like NB-IoT, SigFox, Telensa, and Ingenu RPMA or a combination thereof (such as for redundancy purposes or if more than one protocol is used in a particular jurisdiction) may be used as well in other embodiments.

Example 3. The selected Tx-Rx setup was experimentally tested to determine the feasibility of CERPM in terms of providing a successful wireless communication. A received signal strength indicator (RSSI) can be determined using:

$${P}_{R} = {P}_{0} - 10 η {log}_{10} ( \frac{d}{{d}_{0}} )$$

where P_{R} is the received power in dBm, η denotes the path loss exponent (PLE); P₀ stands for the path loss at d₀; d and d₀ are the distance between the transceiver and receiver (Tx-Rx) and the reference distance for path loss measurements, respectively.

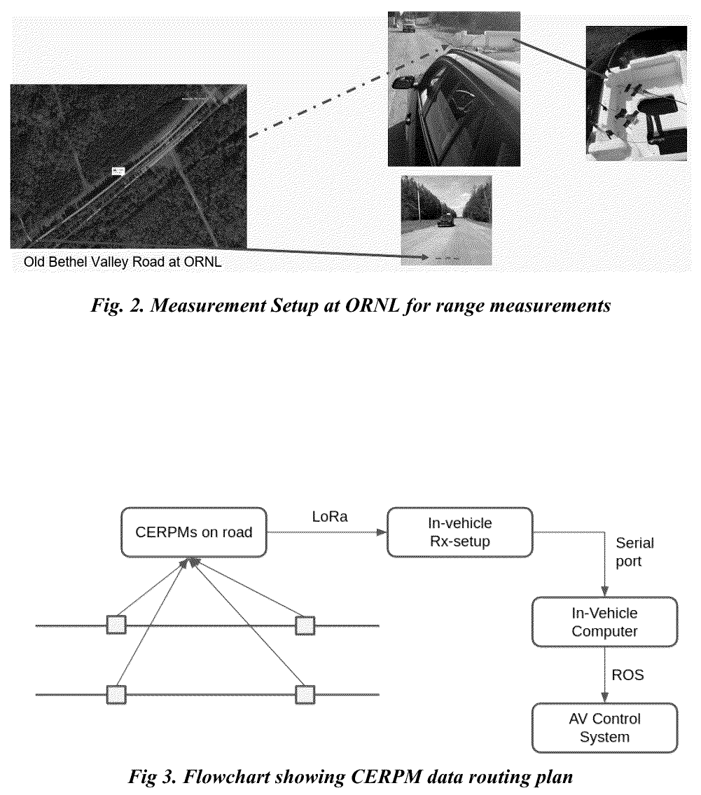

Tests were carried out with a roadside CERPM, capturing the RSSI, signal-to-noise ratio (SNR), CERPM identification (ID), and GPS coordinates. Measurements were taken over a 10 m to 535 m Tx-Rx distance (at 25 m intervals) in which d₀=10 m. The Rx was mounted on top of a 2015 BMW X1 vehicle at a height of 1.55 m above Tx. The entire measurement setup for range measurements is shown in FIG. 2.

Example 4. With the incoming data from Tx LoRa nodes, LoRa Gateway forwards all the radio packets to the Rx LoRa node after adding metadata such as SNR and RSSI. Data messages to be transmitted from the CERPMs must be properly defined. Required data for lane and drivable region detection were identified as the GPS coordinates (latitude, longitude, and altitude) of the CERPM location and a unique CERPM ID for each CERPM. The GPS coordinates of the CERPM location were measured using a high-precision GPS sensor from Trimble Catalyst and each CERPM was programmed using the Heltec Arduino LoRa Library to broadcast the preloaded GPS coordinates with the CERPM id, SNR, and RSSI in packets.

In practice, CERPMs may be preloaded with location data prior to or after road placement with remote programming, or may use native GPS locators to obtain their location after placement.

Average packet size of the messages sent from one CERPM was around 47 bytes. In-vehicle Rx setup placed at the top of the vehicle was programmed to receive packets sent by the CERPMs. In-vehicle Rx and CERPMs were programmed to operate in the United States' unlicensed industrial, scientific and medical (ISM) radio frequency band of 915 MHZ.

With the integrated CP2102 USB to serial chip, a serial communication was established, which enabled data transfer between the Rx setup and the in-vehicle PC of an autonomous research vehicle (Kia Niro Hybrid 2016). A Python program was written to read in the data coming in through the serial port. Sensor communication to the research vehicle is facilitated via Robot Operating System (ROS). A ROS node was created to read in the program data output. The creation of a ROS node also helps ensure CERPM data are available to the AV control system for sense and perception. The entire data routing flowchart can be seen in FIG. 3.

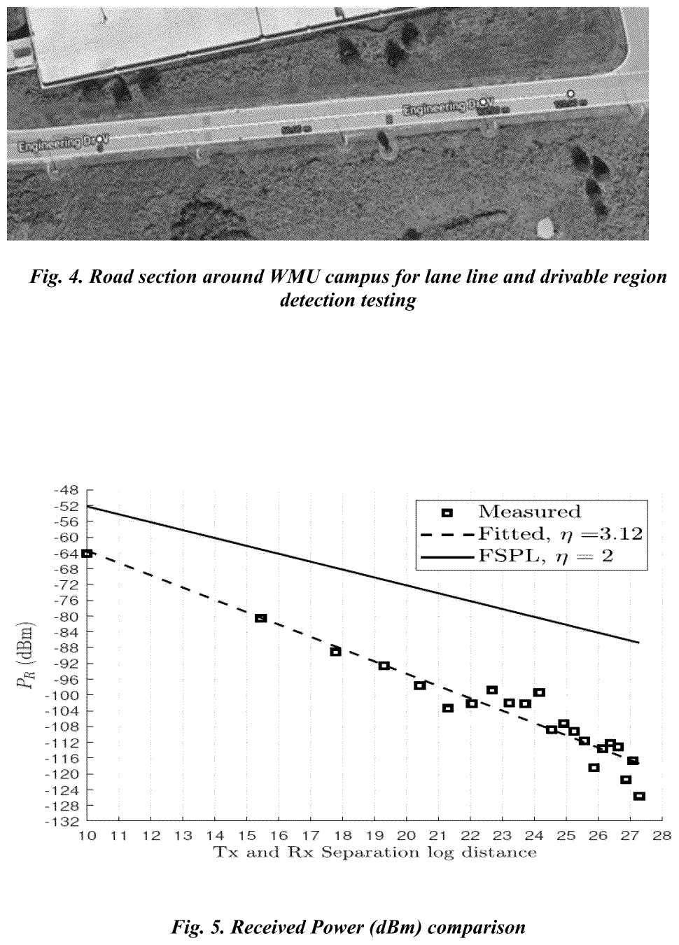

Example 5. The GPS points coming in from the CERPMs were overlaid onto the camera feed of the research vehicle to show lane line and drivable region detection. GPS coordinates transmitted by CERPMs were converted from WGS84 (World Geodetic System 1984) form into global North East Down (NED) form. A Zed2i camera was used; points were projected into the camera feed using the projectPoints function from the Python OpenCV image processing library. Lane lines were modeled by fitting a cubic function on the CERPM points. For this experiment, six CERPMs were placed on a straight section of road. The CERPMs were placed directly on top of the middle yellow lane line in the road section shown in FIG. 4. The distance between two consecutive CERPMs was kept at 10 m for this initial investigation, as US Department of Transportation (DOT) guidelines suggest that the spacing between conventional RPMs used on lane boundaries on straight tangents should be less than 24.40 m.

Example 6. The received power from the CERPM at do and subsequent points was taken as the mean of five measurements at the testing environment shown in FIG. 2. FIG. 5 shows the received power using a free-space path loss (FSPL) model with n=2 and measured data with an estimated PLE of n=3.12. The difference between PLE values stems from the fact that the antenna is placed inside the CERPM, vegetation and transition from line of sight (LOS) to non line-of-sight (NLOS). Range measurements may vary depending on different environmental conditions and mobility scenarios, but the results from initial investigation made a case for an appropriate CERPM range. Optimal CERPM distance may also vary as a function of road curvature.

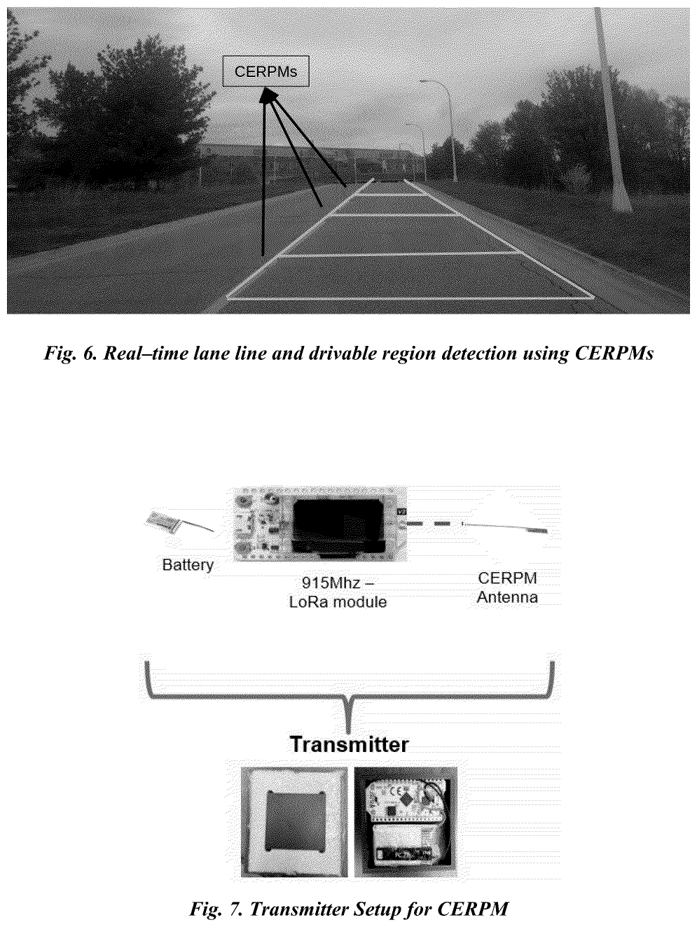

Example 7. The output of the developed program for lane line and drivable region detection is provided in FIG. 6 for the measurements taken at the road section in FIG. 4. Energy consumption of the Rx setup for drivable region detection was 0.55 W. In comparison to the commercially available Mobileye, our approach to lane-line detection used 9.5 times less power, a 90% reduction.

In summary, the examples demonstrate the development, testing, and viability of CERPMs as an infrastructure-based perception aid for AVs. A CERPM example embodiment was developed to transmit GPS coordinates of their location. The results showed a successful wireless communication between CERPM and the in-vehicle PC at a distance up to 535 m. Thus, the usefulness of CERPMs for a major AV perception task, lane line and drivable region detection, was shown, including an energy savings of at least 90%.

### CERPM and Sensor Fusion.

To make the most of these energy savings, an energy-efficient sensor fusion strategy can be established if the update frequency of camera measurements can be lowered, as these demand higher energy use. In this approach, high level semantic information obtained from sensor camera(s) is not lost and can still provide accurate positioning information by relying on CERPM, at a reduced computational load.

Here, we show a sensor-fusion strategy for AV lane keeping using inputs from a traditional imaging sensor (here, an onboard camera) and infrastructure sensors. The lateral offset of an AV or SAV from the center of the lane can be assessed using CERPMs, cameras and a combination of both for increased energy savings. For a vehicle in a lane, ΔY, as shown in FIG. 7 is the perpendicular distance between a line that passes through the center of the lane and a line that passes through the center of gravity of the vehicle.

The following examples show (1) Real world-like sensory data generated using a CARLA simulator. CERPMs were simulated inside the CARLA simulator. Image messages from camera sensors and GNSS messages from CERPMs were published through Robot Operating System (ROS) nodes (2) A Kalman Filter is applied to predict ΔY using information from CERPMs and camera messages. (3) Camera-CERPM group sensor fusion is employed in harmony to predict ΔY. (4) Camera-CERPM asyncronous sensor fusion is further evaluated to predict ΔY.

Example 8. In this example, we describe lateral lane offset estimation using inputs from camera and CERPMs separately. Sensor data-fusion methodologies are formulated and tested in the CARLA simulator.

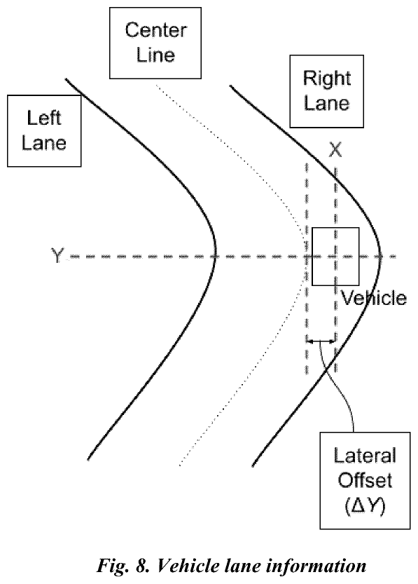

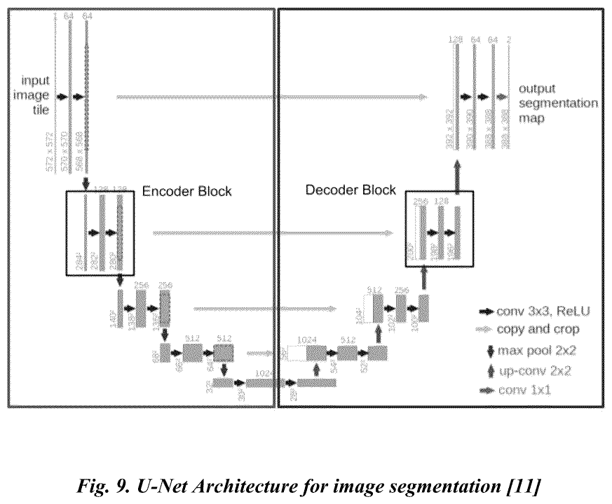

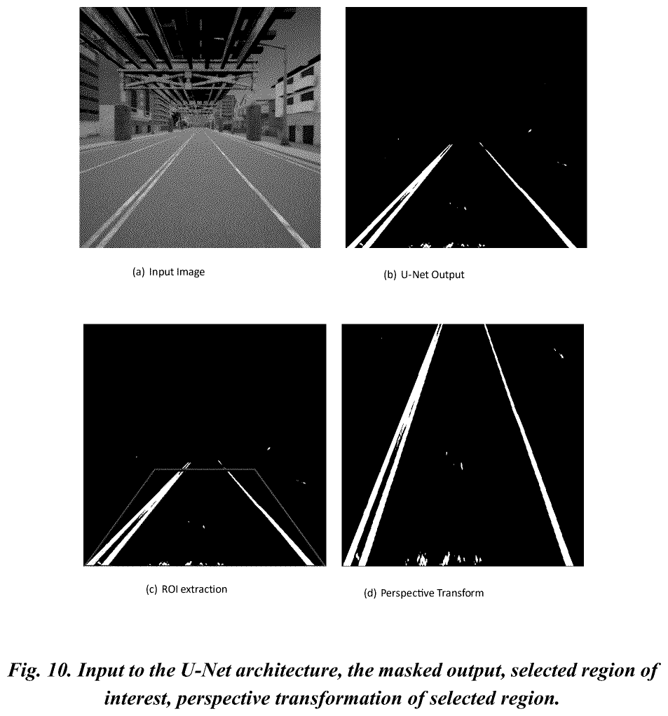

Lateral offset estimation starts at lane line detection. For lane detection, an encoder-decoder DCNN, UNet was used. U-Net is a fully convolutional network which has been demonstrated to be applicable to various semantic segmentation purposes. Raw images of size 512×512×3 were converted into grayscale images with a single channel and passed through the U-Net segmentation architecture as shown in FIG. 8. The output of the U-Net architecture is a masked image, where lane pixels are identified after threshold processing to remove associated interference. Step-by-step explanation of a series of steps performed to get the lateral offset from the masked image are described below and illustrated in FIGS. 9 and 10.

1. Perspective transform to extract region of interest (ROI): The input to this stage is the masked image shown in FIG. 9(b) which is converted to a top-down view of the ROI using perspective transform as shown in FIG. 9(d) and reduce subsequent processing. The four vertices of the region to be processed were identified and are shown in FIG. 9(c) and the equation below was used to map the relationship between pixel (x, y) of the top-down image and pixel (u, v) of the masked image

$$[ \begin{matrix}x \\ y \\ 1\end{matrix} ] = [ \begin{matrix}{a}_{1} & {a}_{2} & {b}_{1} \\ {a}_{3} & {a}_{4} & {b}_{2} \\ {c}_{1} & {c}_{2} & 1\end{matrix} ] [ \begin{matrix}u \\ v \\ 1\end{matrix} ]$$

where

$$[ \begin{matrix}{a}_{1} & {a}_{2} \\ {a}_{3} & {a}_{4}\end{matrix} ]$$

is the rotation matrix,

$$[ \begin{matrix}{b}_{1} \\ {b}_{2}\end{matrix} ]$$

denotes the translation vector, and [c₁ c₂] represents the projection vector. Perspective transformation eliminates the majority of image interference and projects the lane lines to a relatively parallel position to make subsequent processing easier.

2. Lane fitting: Traditional lane-search algorithms are based on Hof linear transformation, which requires input images of high resolution and does not adapt to real scenes with high interference due to poor recognition effect. A bottom-up scanning approach known as the sliding window algorithm was utilized to identify and track the lane lines as shown in FIG. 10(a). This method preserves the coordinate of the non-zero pixels inside the windows and adjust the position of the next window accordingly. Quadratic curves are fitted along the right and left lines using the least square method.

3. Lateral offset estimation: After lane fitting, a coordinate system was established where the vertical center line of the image is considered as the X-axis and horizontal line at the bottom of the image is considered as the Y-axis. Assuming the center of the vehicle is the center of the image and the origin of the Y-axis at the center of the lane and considering d₁ and d₂ as the Y-pixel locations of the bottom left and bottom right lines respectively, the pixel location of the lane center d₃ is calculated as the average of d₁ and d₂. The lateral offset, ΔY can be calculated using

$$Δ Y = {d}_{3} ( MPP )$$

where MPP is the meters per pixel in the horizontal direction to convert the distance units from pixels to meters.

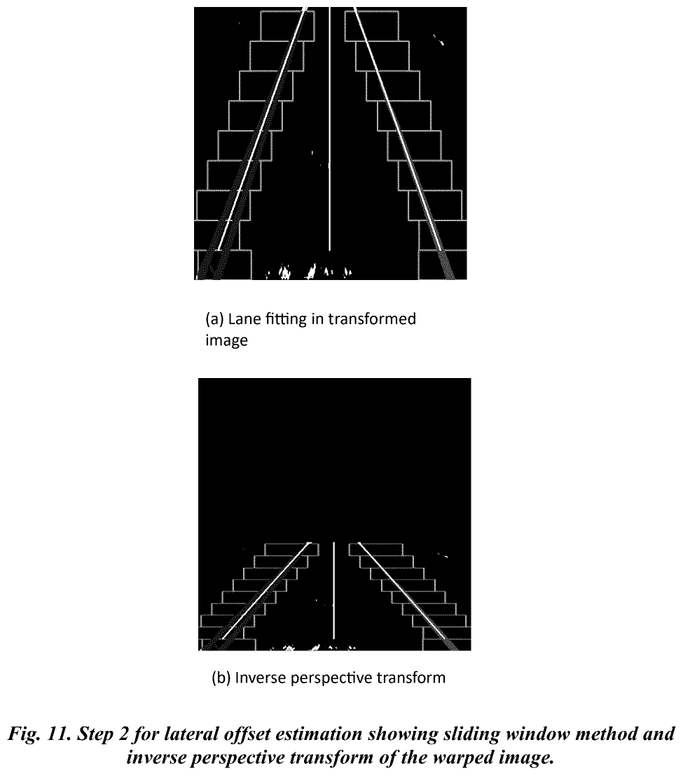

Example 9. Lateral Offset Estimation Using CERPMs. The CERPMs transmit GNSS location (latitude, longitude, and altitude) of their location to the vehicle computer. GlobalGNSS messages from CERPMs were converted into Cartesian coordinates (x, y) using

$$x = R cos ( λ ) cos ( ϕ )$$

$$x = R sin ( λ ) sin ( ϕ )$$

where λ and φ are the difference in target and current latitude and longitude in radians, respectively, and R is the radius of the earth. Assuming the vehicle's current location in Cartesian coordinates as the origin, the CERPMs are located in the vehicle's frame of reference. Polynomial curves of degree 2 are fitted along the right and left lanes using the least square method. The lateral offset, ΔY can be calculated using:

$$Δ Y - \frac{{d}_{4} + {d}_{5}}{2}$$

where d₄ and d₅ are the y-coordinate of the left and right lanes, respectively, in the vehicle's frame of reference. FIG. 11 shows the detected left and right lanes from the CERPM information.

Example 10. Kalman Filter Based Estimators. Estimation of lateral offset at each timestep is input to the pathplanning and controls sub-system for AV lane-keeping. A Kalman filter, an optimal estimator based on a recursive computational methodology for estimating the state of a discrete-data controlled process from typically noisy measurements was used to model the lateral offset over time in the y-direction. The linear time invariant system subject to random process noise w (k) and measurement noise v (k) and uncertain random initial condition can be modeled as

$$x ( k + 1 ) = Ax ( k ) + Bu ( k ) + Gw ( k )$$

$$z ( k ) = Hz ( k ) + v ( k )$$

where A, B, G, z, and H denote system matrix, input matrix, process noise gain matrix, sensor measurement model matrix and measurement, respectively. The Kalman filter involves a series of steps for state estimation, which are reviewed in the Appendix section (Equations A1-4). The linear time invariant system specific to our measurements for lateral offset estimation is shown in the below equations where Δ_{y} is the lateral offset from the center line and V_{y} denotes the lateral velocity of the vehicle.

$$[ \begin{matrix}Δ y ( k + 1 \\ {V}_{y} ( k + 1 )\end{matrix} ] = [ \begin{matrix}1 & Δ t \\ 0 & 1\end{matrix} ] [ \begin{matrix}Δ y ( k ) \\ {V}_{y}\end{matrix} ] + [ \begin{matrix}0 \\ \frac{Δ {t}^{2}}{2}\end{matrix} ] v ( k )$$

$${z}_{y} ( k ) = [ \begin{matrix}1 & 0\end{matrix} ] [ \begin{matrix}Δ y ( k ) \\ {V}_{y} ( k )\end{matrix} ] + v ( k ) .$$

Example 11. Group sensor method for Camera-CERPM fusion. The group sensor method combines measurements for all sensors and measurement model into a single sensor and its formulation is based upon synchronized measurements. If the lateral offset measurements coming from the camera and CERPMs can be synchronized, a group sensor method can be formulated to fuse information coming from camera and CERPMs. The measurement model for linear time invariant system for group sensor method is shown below. The variables z₁₍ₖ₎ and z₂₍ₖ₎ are the offset measurements coming from the camera and CERPM, respectively, and v₁ and v₂ are corresponding measurement noise for each sensor:

$$[ \begin{matrix}{z}_{1 y ( k )} \\ {z}_{2 y ( k )}\end{matrix} ] = [ \begin{matrix}1 & 0 \\ 1 & 0\end{matrix} ] [ \begin{matrix}Δ y ( k ) \\ {V}_{y} ( k )\end{matrix} ] + [ \begin{matrix}{v}_{1} ( k ) \\ {v}_{2} ( k )\end{matrix} ]$$

Example 12. Asynchronous sensor fusion for Camera-CERPM. To investigate energy efficient sensor fusion strategy, the frequency of camera sensor (frames per second) can be decreased keeping the frequency of CERPM information same as before, an asynchronous estimator can be formulated. For asynchronous measurement cases, the time between 1, 2, . . . , k−1, k may not be constant. If we consider T_{S,k} as the current time step which is the time between k−1 and k, the process model over T_{S,k} is shown below as

$$[ \begin{matrix}Δ y ( k + 1 ) \\ {V}_{y} ( k + 1 )\end{matrix} ] = [ \begin{matrix}1 & {T}_{S , k} \\ 0 & 1\end{matrix} ] [ \begin{matrix}Δ y ( k ) \\ {V}_{y} ( k )\end{matrix} ] + [ \begin{matrix}0 \\ \frac{{T}_{S , k}^{2}}{2}\end{matrix} ] w ( k )$$

where A_{T}_{_{s,k}}, B_{T}_{_{s,k}}, G_{T}_{_{s,k}}, and HA_{T}_{_{s,k}} need to be evaluated at each k as T_{S,k} is not constant.

Example 13. Simulation Setup. The simulation setup is discussed first, and then the results for estimates using different sensor fusion strategies are provided in subsequent examples.

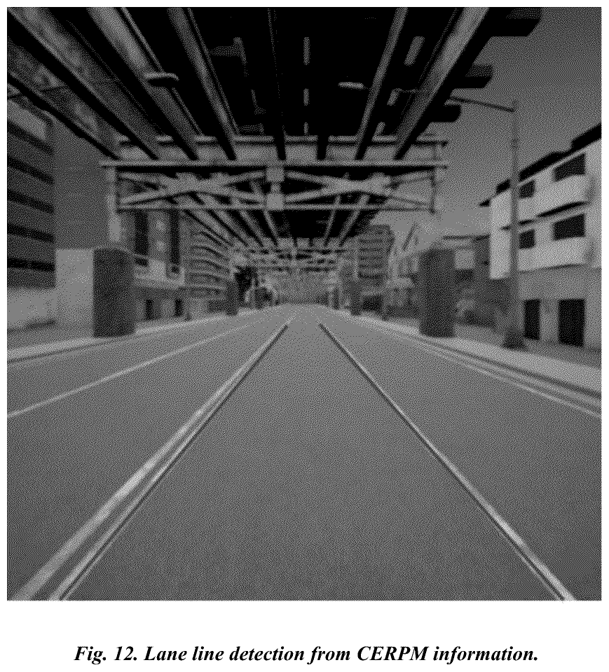

CARLA is an open-source simulator utilized for developing, validating, and testing algorithms for AV systems. CARLA offers a simulation setting with a variety of sensor specifications, environmental factors, and automobiles, among other things. It gives the user the power to design environments that can be tested and validated for autonomous/ADAS driving behaviors. To facilitate two-way communication with the Robot Operating System (ROS), a CARLA-ROS bridge can be used to get information from the CARLA server. For the camera sensor, the sensor update rate, image size, field of view, and spawn points are customizable inside the simulator. CERPMs that transmit GNSS message of their location were modeled in the simulator and the sensor update rate was kept at a constant 20 Hz for all of the test cases. CERPMs were spawned at both left and right lanes and the adjacent distance between the CERPMs was kept at a length of 5 m. A vehicle was spawned in ‘Town03’ of the CARLA simulator and a route was chosen to evaluate the lateral offset estimators formulated in the methodology section. FIG. 12 shows the longitudinal and lateral position of the vehicle when travelling on the chosen route.

The CARLA simulator has waypoints, which are 3D directed points corresponding to a lane. The location of the center of the lane was calculated as the midpoint between the right and left lanes. The CARLA simulator publishes pose information to ROS as odometry messages. The true lateral location of the simulated vehicle was subtracted from the lateral location of the center of the lane to get the ground truth data.

Example 14. Lane Lateral Offset Estimation Setup. Lateral offset estimators were developed using single sensory outputs from individual sensors. First, the lateral offset estimator was modeled for the camera. The measurement noise associated with lateral offset measurement can be divided into: (a) measurement noise associated with the camera sensor itself, (b) measurement noise associated with the mask generated by U-Net. As the image obtained through the CARLA simulator is undistorted, the measurement noise associated with the camera sensor is 0. The mean intersection over union (mIoU) of the trained U-Net model for mask generation was 98%. For a 512×512×3 channel image, the measurement noise in meters was calculated as:

$${σ}_{p Δ y} = ( 1 - mIoU ) W$$

$${σ}_{p Δ y} = {σ}_{p Δ y} {D}_{0}$$

where W is the width of the image, σpΔy stands for the standard deviation of the offset in pixels, σΔy denotes the standard deviation of the offset in meters, and D₀ represents the meter per pixel value for Town03 in the CARLA simulator (given as 0.4 cm). The v (k) for camera measurements was modeled as a normal distribution with zero mean and a standard deviation of 4 cm as calculated using the above equations.

The overall measurement noise v (k) associated with CERPM and GNSS derived offset measurements can be determined by adding var (X) and var (Y), since CERPM and GNSS measurements are independent where var (X) and var (Y) are measurement noise associated with CERPMs and GNSS, respectively. Modern GNSS systems incorporate real-time kinematic (RTK) positioning which uses carrier-based ranging and provides position estimates up to centimeter level accuracy. Likewise, preloaded GNSS points in the CERPMs are assumed to be measured using a GNSS sensor that is capable of providing RTK corrections. Measurement noise of mean 0 with 1 cm standard deviation was added to CERPM measurements and the in-vehicle GNSS sensor, hence modelling the overall v (k) as a normal distribution with mean 0 and standard deviation of 2 cm.

Process noise, w (k) for linear time invariant systems formulated in the equations in Example 10, is the lateral acceleration of the AV. A lateral acceleration value of 0 mean and 0.1 g standard deviation was used to model w (k) for both offset measurements.

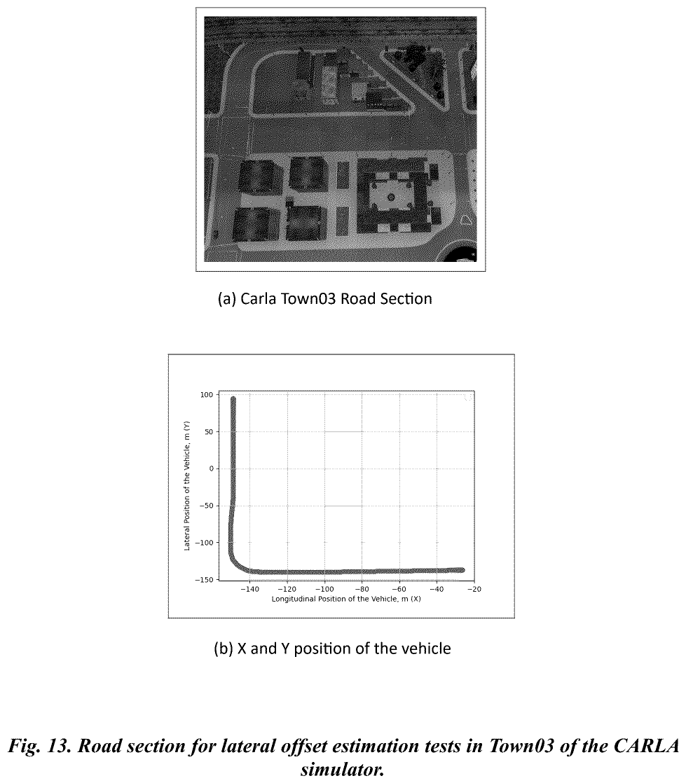

Example 15. Lane Lateral Offset Estimation Simulation Results. To evaluate the lateral offset estimators developed in the above examples, ground truth lateral offset data was obtained from the simulator. Lateral offset estimators using single sensory inputs were modeled first and are shown in FIGS. 13(a) and 13(b). Measured values, estimates, and ground truth offsets are plotted and the root mean square error (RMSE) for measured values and estimates were calculated. Measured values had an RMSE of 1.65 cm and estimates had an RMSE of 1.58 cm for model based on CERPM offset measurements. Likewise for the camera offset measurement model, the RMSE of measured values was 3.01 cm and the RMSE for estimates were 2.10 cm.

A time synchronizer function in ROS within the message filters utility library takes in messages of different types from multiple sources and outputs them only if it has received a message on each of those sources. After message synchronization, the group sensor model described in the equation in Example 11 was applied to estimate the lateral offset of the ego-vehicle. RMSE of the fused output using group sensor method was 1.52 cm.

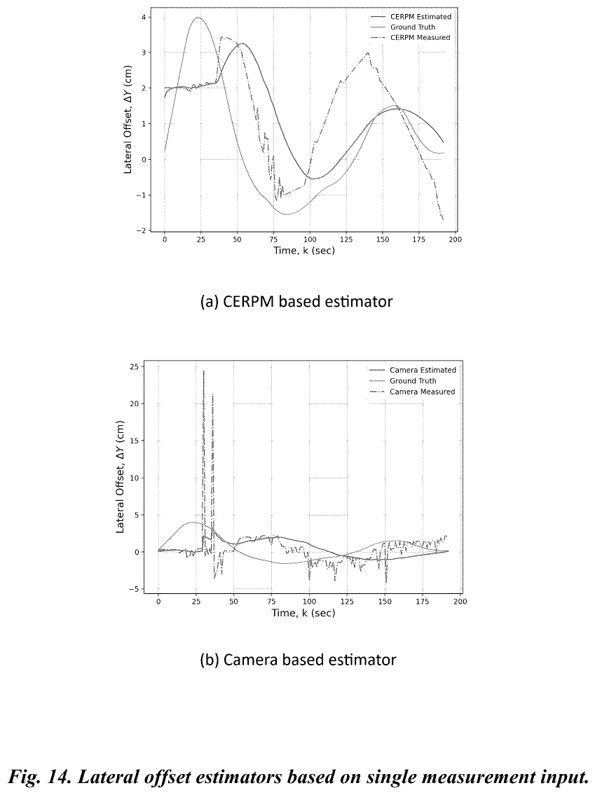

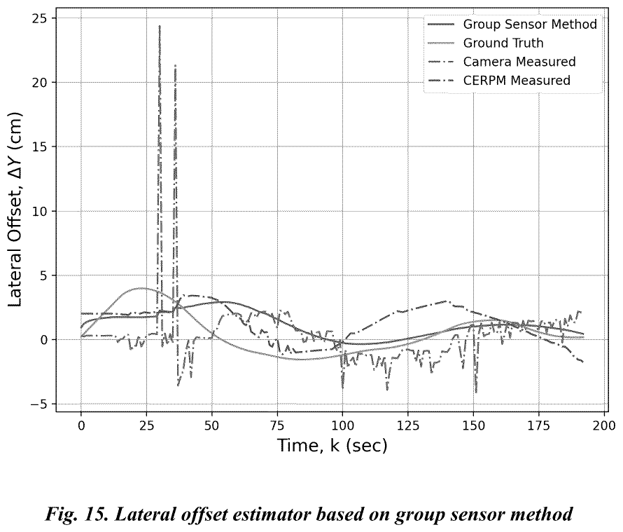

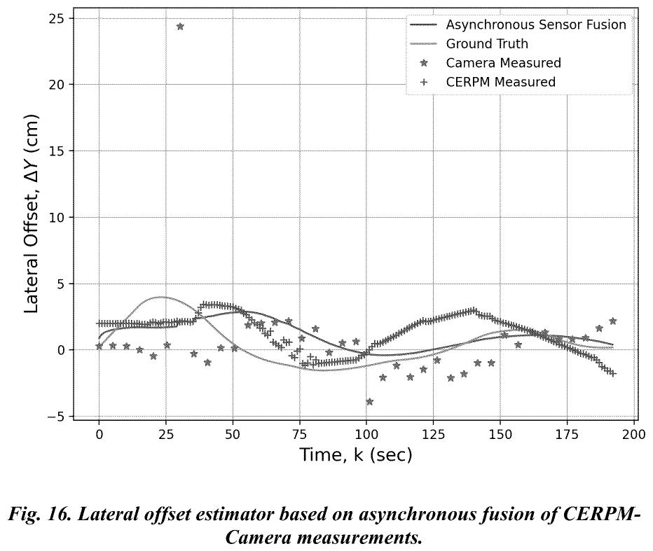

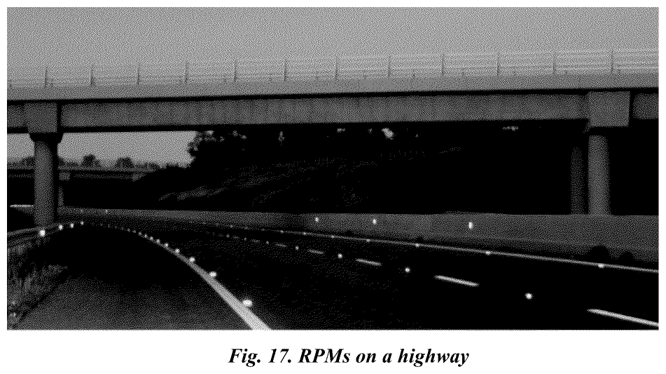

The AVE vehicle obtains continuous information from the CERPMs with a very low computational load associated with it. On the other hand, raw image output needs to undergo a series of steps before outputting the lane offset. With added functionalities from the CERPM, the frequency of image messages per second can be decreased, which will decrease the computational load associated with image processing. The camera update rate was decreased to 5 frames per second from 20 frames per second and the asynchronous model shown in the equation in Example 12 was used to obtain lateral offset estimates. FIG. 14 shows the comparison of lateral offset estimates obtained from asynchronous fusion with camera measurements, CERPM measurements, and the ground truth measurements. The RMSE of fused output using asynchronous sensor fusion was 1.55 cm. This method produced lateral offset estimations that were nearly as accurate as those produced by group sensor method while decreasing the computational need associated with image processing by 4 times as the camera update rate was decreased from 20 frames per second to 5 frames per second for the asynchronous sensor fusion method. This translates into an approximate reduction of compute load power of 4 times for image processing as shown in Table 1 below.

TABLE 1
Table showing required compute load for different
lateral offset estimation methods. CL_{cam} and
CL_{CERPM} are compute load required for image
processing at 20 frames per second and CERPM
measurements at 20 Hz respectively.

| Method | Compute Load |
|---|---|
| Group Sensor Method | CL_{cam} + CL_{CERPM} |
| Asynchronous Sensor Fusion Method | $\frac{1}{4} {CL}_{cam} and {CL}_{CERPM}$ |

This disclosure presents lateral lane offset measurement estimators based on inputs from the camera sensor, CERPMs, and combinations of both. Four different example estimators were shown, modeled and tested in a road section of CARLA simulator: camera alone, CERPM alone, group sensor fusion, and asynchronous sensor fusion. The RMSE of the offset measurements when compared to ground truth were within 2.2 cm. The group sensor method had the lowest RMSE among the models tested. When compared to asynchronous sensor fusion, the RMSE of the group sensor method is lower by 0.03 cm, but the computational load associated with image processing in group sensor method is estimated to be four times more than the asynchronous method. Asynchronous fusion allows for the fusion of highly accurate lateral offset measurements from CERPMs, which have a higher update rate, with image-based offset measurements, which have a lower update rate, for improved lane keeping while preserving high-level semantic information and conserving energy.

In other embodiments, data fusion from other IISs like HD maps and radar retroreflectors may provide more accurate offset measurements, in a variety of adverse situations, such as on rural roads, inclement weather, and in locations with poor GNSS coverage.

It is expected that embodiments and aspects of the current disclosure will be robust against a wider variety of measurement noises, as could be expected in the real world, as well as adjust to communication impairments between an AV or SAV and CERPMs on the road. In these situations, estimated lane lines will be evaluated for goodness of fit before being used or not.

For the purposes of Examples 8-14, the on-board GNSS receiver is simulated as a contemporary GNSS system that includes RTK and offers location estimates with a precision of up to 2 cm. It is expected that lateral lane offset measurements will be estimated in a traditional GNSS system which typically has a higher measurement error.

Communications with AVs can be integrated with a centralized system for AV control and wide-range data management if an RSU is located nearby that includes long-range wireless protocol.

Alone or in combination with sensor fusion systems, this new type of Chip Enabled RPM could be widely adopted by both federal and state DOTs and purchased and installed in a large array of roadways, such as low visibility roads (fog, glare, large vertical/horizontal curves); smart work zones (lane closure, lane shifting); ‘do not enter’ areas; variable speed limit areas; emergency communications; and will increase in coverage of roadways as AV penetration rates increase.

The ubiquity of RPMs means that CERPMs can be placed wherever needed in a flexible manner without adding excessive costs to enable short-range communications along with sensing and data collection/transmission capabilities. Sharing data with passing vehicles, both CAVs and human driven, can improve vehicle situational awareness or enable new functionality in CAVs. Different data types can be shared with vehicles, and the data communications can be either 1-way (CERPM-to-vehicle) or 2-way, which would allow receiving data from vehicles regarding nearby traffic conditions, speed data, etc.

A variety of different functions are possible depending on sensor options included. As an example of one implementation, high definition (HD)/high resolution map data that provides detailed information of roadway lane line locations and drivable range for the local area can be transmitted by CERPMs to vehicles, which can enable positional awareness under extreme weather conditions and GPS-denied environments. This HD map data enables CAVs to improve perception of the local roadway with reduced computational requirements and can aid human drivers in identifying lane lines if they are not visible (for example by using a heads-up display that clearly show the vehicle's position in the lane even when visibility is poor due to poor lighting, rain, snow, etc.). HD map data may also be updated in CERPMs to have accurate temporary information corresponding to lane closures or construction conditions that may change even at different times of the day.

Other capabilities are possible with CERPMs. Using embedded sensors, two-way communications and various sensors or other data from vehicles, it would be possible for CERPMs to provide the following capabilities/functionality:

1. Monitor road traffic conditions using information received from CAVs for speeds encountered along previously traveled segments of the roadway. By processing and sharing this data with CAVs in the opposing direction, warnings can be provided for slow conditions ahead, etc.

2. Share environmental data such as temperature and recent rainfall, which may be used to recommend reduced speeds in areas with high traction requirements (i.e. on curvy roads).

3. Vehicle count data for traffic monitoring and transportation planning purposes

4. Temporary map data corresponding to lane closures or construction conditions that may change even at different times of the day. Data could be modified externally

5. Vehicle trajectory info can be used to refine info for maps/identify inaccuracies.

6. Lane management for toll roads, tracking vehicles and distance traveled.

7. Detection of wrong-way driving (and lights to warn against it)

8. Estimation of location of vehicles for calibration of GPS

9. Estimate trajectories of vehicles: if all AVs drive same wheel path, it gives high loading of the pavement. Could send signal to modify trajectories.

10. Used to help firefighters find fire hydrants or for other emergency responders, and even for identifying/finding other roadside assets or infrastructure.

11. Detailed info communicated back to CAVs; Visual feedback (flashing, change of color, etc.) to Non-CAV vehicles in event of road hazards, etc.

12. Detect and monitor emissions/air quality

13. Cybersecurity functions: validation by “official” source would be enabled

14. Bluetooth identification of passing vehicles (or a phone or other devices inside the vehicle or with a cyclist) to enable estimation of OD/travel time between two points.

What is claimed is:

1. A chip-enabled raised pavement marker (CERPM) comprising:
a transceiver, wherein said transceiver is capable of transmitting the location of the CERPM to a vehicle
wherein said CERPM is capable of being fixed on a roadway surface and has dimensions of standard raised pavement markers.

2. The CERPM of claim 1, wherein said transceiver is capable of transmitting location of the CERPM to a vehicle using a low-power wide-area network (LPWAN).

3. The CERPM of claim 2, wherein said LPWAN uses LoRA, NB-Iot, SigFox, Telensa, and/or Ingenu RPMA.

4. The CERPM of claim 1, wherein the location of the CERPM is indicated with location coordinates.

5. The CERPM of claim 4, wherein the location coordinates are GPS coordinates

6. The CERPM of claim 1, wherein the CERPM is capable of transmitting said location to a vehicle using radio transmission.

7. The CERPM of claim 1, wherein the CERPM further comprises a reflective upper surface capable of aiding in visual detection by vehicle drivers and/or cameras or other visual sensors in autonomous or semi-autonomous vehicles.

8. A method of guiding an autonomous or semi-autonomous vehicle, comprising
using an on-board receiver to receive transmissions from a chip-enabled raised pavement marker (CERPM), wherein the transmissions comprise the location of the CERPM to the receiver;
indicating the position of the vehicle relative to lane lines, edges of the drivable surface and/or obstacles based on the transmitted CERPM signal.

9. The method of claim 8, wherein the receiver communicates to the CERPM using a low-power wide-area network (LPWAN).

10. The method of claim 8, wherein the location of the CERPM is indicated with location coordinates.

11. The method of claim 8, wherein indicating the position of the vehicle based on the transmitted CERPM signal further includes
combining CERPM location data with onboard sensor data to indicate the relative position of the vehicle such that computing the relative position of the vehicle is less computationally intense than using onboard sensor data alone.

12. The method of claim 11, wherein the onboard sensor includes one or more cameras.

13. The method of claim 11, where the onboard sensor includes radar sensors.

14. A system for guiding an autonomous or semi-autonomous vehicle, comprising:
an on-board receiver to receive transmissions from a chip-enabled raised pavement marker (CERPM), wherein the transmissions comprise the location of the CERPM to the receiver; and
an onboard module capable of indicating the position of the vehicle relative to lane lines, edges of the drivable surface and/or obstacles based on the transmitted CERPM signal.

15. The system of claim 14, wherein the receiver communicates to the CERPM using a low-power wide-area network (LPWAN).

16. The system of claim 14, wherein the transmission obtained from the CERPM includes location coordinates.

17. The system of claim 14, further comprising
an onboard sensor capable of obtaining position data relative to lane lines/road edges and or obstacles; and wherein
the onboard module is capable of combining the CERPM location data with the position data from the onboard sensor to indicate the relative position of the vehicle such that computing the relative position of the vehicle is less computationally intense than using onboard sensor data alone.

18. The system of claim 17, wherein the onboard sensor includes at least one camera.

19. The system of claim 17, where the onboard sensors includes at least one radar sensor.

20. The system of claim 14, further comprising
a chip-enabled raised pavement marker (CERPM) including:
a transceiver, wherein said transceiver is capable of transmitting the location of the CERPM to a vehicle
wherein said CERPM is capable of being fixed on a roadway surface and has dimensions of standard raised pavement markers.
